(19) United States
(12) Patent Application Publication
(10) Pub. No.: US 2010/0289723 A1
(43) Pub. Date: Nov. 18, 2010

(54) TELEIDOSCOPIC DISPLAY DEVICE

(76) Inventor: DAVID LONDON, Potomac, MD (US)

Correspondence Address: WOOD AND EISENBERG, PLLC, 3975 University Drive, SUITE 330, Fairfax, VA, 22030, US

(21) Appl. No.: 12/553,983

(22) Filed: Sep. 3, 2009

Related U.S. Application Data
(60) Provisional application No. 61/178,952, filed on May 16, 2009.

(51) Int. Cl. G09G 5/00

(52) U.S. Cl. 345/8; 353/1

(57) ABSTRACT

A body supported teleidoscopic device having an onboard electronic image capture device, such as a digital camera, and a display screen. The teleidoscopic device has an onboard battery and controlling circuitry. The teleidoscopic device may comprise a pistol grip handle for being hand held, or may comprise earpieces so as to be wearable in the manner of eyeglasses. The display screen may be onboard or remote. Where remote, the display screen may be provided with wireless or hard wired connection to the kaleidoscopic image source. The teleidoscopic device may comprise a projector for large scale display of images for group viewing. The teleidoscopic device may be focused on a screen to generate kaleidoscopic imagery using video feedback techniques. The projector and screen may take the form of a television.

### CROSS-REFERENCE TO RELATED APPLICATIONS

This application claims the benefit of priority from U.S. Provisional Patent Application Ser. No. 61/178,952 (filed May 16, 2009). The entire content of Provisional Patent Application Ser. No. 61/178,952 is incorporated herein by reference in its entirety.

### STATEMENT REGARDING FEDERALLY SPONSORED RESEARCH OR DEVELOPMENT

Not Applicable.

### FIELD OF THE INVENTION

The present invention pertains to amusement devices of the type which display kaleidoscopic optical effects, and more particularly to a device which incorporates electronic capture and handling of kaleidoscopic optical effects.

### BACKGROUND OF THE INVENTION

Kaleidoscopes have long been used as amusement devices. In a conventional kaleidoscope, the user holds a tube-shaped device up to their eye to view a complex pattern of changing colors and shapes. The tube-shaped device is rotated to produce a succession of symmetrical designs by means of mirrors reflecting the constantly changing patterns made by bits of colored glass at one end of the tube. The kaleidoscope modifies the viewable image based on the bits of colored glass by breaking that image up into partial images which are redundantly presented to the user in close proximity to one another.

A teleidoscope is a type of kaleidoscope, which has a lens and an open view, so that it can be used to form kaleidoscopic patterns from objects outside the instrument, rather than from items inside the tube chamber. The teleidoscope modifies the viewable image by breaking that image up into partial images which are redundantly presented to the user in close proximity to one another. Usually, there is sufficient distortion from the actual viewable image such that a whimsical or abstract image results, with the actual viewed scene not being recognizable as such.

In addition to transforming an actual image to a whimsical, abstract image, a teleidoscope can change the whimsical, abstract image dynamically. That is, as the user moves the device about and brings different portions of the viewable environment into focus, the whimsical, abstract image changes accordingly.

Teleidoscopes can be used in other ways beyond that of holding a simple mechanical teleidoscope to the eye. For example, it is known to couple a teleidoscope to a video camera. It is known to reproduce teleidoscope optical effects for group viewing. Nonetheless, there exists a potential to expand the traditional concept of teleidoscopes.

### SUMMARY OF THE INVENTION

In one aspect of the invention, the present invention expands the traditional concept of kaleidoscopes and teleidoscopes by introducing new forms of teleidoscopes. In one aspect, the new forms which provide electronic image capture to the kaleidoscopic process may be body worn or supported. These images may then be subject to handling in ways which are beyond the abilities of traditional kaleidoscopes and teleidoscopes. For example, a kaleidoscopic image may be projected on a small screen carried on the user's body, may be projected on a larger screen where many viewers may view the images, transmitted remotely using communications channels, and digitally stored, to name some if not all of the possibilities. As employed herein, the term “kaleidoscopic image” will signify the visual end product both of kaleidoscopes and of teleidoscopes, since the optical effect arising from the two or more mirrors, three mirrors typically being used, are similar even if the source images are not.

In another aspect, kaleidoscopes may be grasped, worn, or otherwise supported on the user's body in ways not traditionally used.

In a further aspect, the invention produces images based not on clearly defined internal or environmental objects as image sources, but on video feedback.

The present invention thus produces new amusement devices incorporating new ways of configuring, generating, and using kaleidoscopic effects, and incorporating electronic imaging and transmission of imaging.

### BRIEF DESCRIPTION OF THE DRAWINGS

FIG. 1 is a perspective view of a teleidoscopic device according to at least one aspect of the invention.

FIG. 2 is a perspective view of the device of FIG. 1, showing wireless communication with a second component.

FIG. 3 is a perspective view of the device of FIG. 1, showing hard wired communication with a second component.

FIG. 4 is a side elevational, environmental view of a teleidoscopic device according to at least one further aspect of the invention.

FIG. 5 is a side elevational view of the device of FIG. 4, showing wireless communication with a second component.

FIG. 6 is a side elevational view of the device of FIG. 4, showing hard wired communication with a second component.

FIG. 7 is a diagrammatic view of an alternative display scheme usable with the invention.

FIG. 8 is a perspective view of a teleidoscope according to at least one aspect of the invention, used in conjunction with other apparatuses in using video feedback to generate kaleidoscopic images.

FIG. 9 is a block diagram of steps of a method of using video feedback to generate kaleidoscopic images, for example, using the apparatus of FIG. 8.

FIG. 10 is a perspective view of a teleidoscope according to at least one further aspect of the invention, used in conjunction with other apparatuses in using video feedback to generate kaleidoscopic images.

FIGS. 11A through 11C define a table that includes a table of reference numerals and the elements to which they refer.

### DETAILED DESCRIPTION

FIG. 1 shows a teleidoscopic device 100 for generating and displaying kaleidoscopic images according to at least one aspect of the invention. The terms “teleidoscope” and “teleidoscopic device” are hereinafter regarded as equivalent terms.

The teleidoscopic device 100 may comprise a mounting structure 120 for engaging the human body (not shown) and being supported thereon. More particularly, the mounting structure 120, which may be worn in a manner akin to that of eyeglasses, may comprise a front section 140 which spans the eyes of the wearer, a first ear piece 160, and a second ear piece 180. The ear pieces 160, 180 are disposed to engage a person's head and ears, and to be capable of being supported on the head such that the device 100 is wearable as are eyeglasses. The ear pieces 160, 180 may be integrally formed with the front section 140, as shown, or alternatively, may be hinged thereto or otherwise connected. The front section 140 may cooperate with the face of the person who wears the device 100, for example, by incorporating a recess 190 adapted to follow the contours of the bridge of the nose. The front section 140 spans and connects the two ear pieces 160, 180 and covers the person's eyes when the device 100 is worn.

Carried on the mounting structure 120 are a kaleidoscopic optical assembly 200 which is disposed to generate kaleidoscopic images from the environment in conventional manner, for example, by comprising at least two mirrors (such as the three mirrors arranged as seen in FIG. 4), and an electronic image capture device 220 which is disposed in image capture relation to the kaleidoscopic optical assembly 200. The kaleidoscopic optical assembly 200 may be a conventional kaleidoscopic lens and mirror arrangement. The electronic image capture device 220 may be a digital camera for example.

As employed herein, “kaleidoscopic” and “teleidoscopic” may in certain instances be used interchangeably. This would apply when the term refers to the optical effect generated by displaying source imagery redundantly, typically three times, depending upon the number of mirrors used, such that when made visible to the observer, the source imagery appears as an abstract image radiating symmetrically from a central point. Such images may be said to be kaleidoscopic regardless of whether the source images were obtained from within the device (i.e., kaleidoscopic), or from without (i.e., teleidoscopic). However, when the term is used to refer to source imagery obtained from outside the device, then only the term “teleidoscopic” would be appropriate.

A display screen 240 which is disposed to receive images from the electronic image capture device 220 and to display these images may be mounted on the mounting structure 120. More particularly, the front section 140 may support the display screen 240, with the latter located in front of the person's eyes when the device 100 is worn by the user.

It should be mentioned at this point that technology to implement image capture and display may be taken from that of digital cameras, cellular or mobile telephones, and like electronic devices. Also, it will be understood that the device 100 has circuitry to connect all electrically powered components to arrive at an operable system. Circuitry will be understood to include all conductors, switches, transducers, and other components required for operability. The present invention lies in the format and arrangement of these components, not in the components per se. Circuitry will be understood to include a suitable source of electrical power such as a battery cell 260, which may be carried aboard the mounting structure 120 and which is disposed to supply operating power to the image capture device 220 and to the display screen 240.

Noting that the ear piece 160 is aligned parallel to the natural direction of vision of a person, the kaleidoscopic optical assembly 200 may be mounted on the ear piece 160 and may be optically focused in a direction parallel to the length of the ear piece 160. The length of the ear piece 160 coincides with the optical axis 280 of the kaleidoscopic optical assembly 200. The natural direction of vision is represented by a projection line 300, it being understood that the direction of vision can change with eye movements and is subject to minor variation due to parallax arising from stereoscopic vision.

The device 100 may display kaleidoscopic effects directly to the user by the display screen 240. As an alternative, or in addition to displaying effects on the display screen 240, the device 100 may transmit kaleidoscopic imagery remotely.

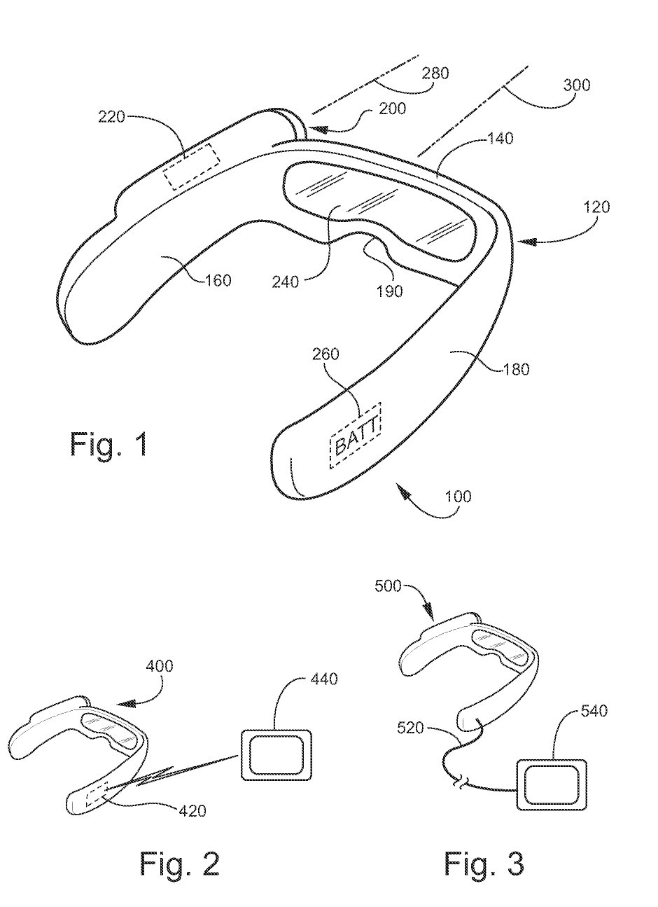

Referring now to FIG. 2, a teleidoscopic device 400 is shown. This teleidoscopic device 400 may be similar in structure and function to the teleidoscopic device 100, except that the teleidoscopic device 400 has image transmission circuitry which may include a transmitter such as a radio frequency transmitter 420 to establish a wireless link. Kaleidoscopic images from an image capture device (not shown, but which may be similar to the image capture device 220 of FIG. 1) may be transmitted to a physically remote display screen 440, which incorporates a suitable receiver (not separately shown). The benefit of using the display screen 440 is that imagery produced by the kaleidoscopic device 400 may be viewed simultaneously by members of a group, as well as by observers who may be remote from the site of image capture.

FIG. 3 shows a variation of the arrangement of FIG. 2. In FIG. 3, a teleidoscopic device 500, which may be similar in structure and function to the teleidoscopic device 400, is equipped with image transmission circuitry including a hard wired connection utilizing a solid conductor 520 which extends continuously from the image capture device to transmit imagery to a remote display screen 540. Of course, the solid conductor 540 may comprise physically separate individual conductors. Continuity of the solid conductor 520, for the purposes of this disclosure, signifies that signal transmission relies entirely upon solid or hard wired conductors, and not on wireless transmission.

FIG. 4 shows a teleidoscopic device 600, wherein the mounting structure comprises a housing providing a manual handle 620 conforming to the human hand H. Internal components of the teleidoscopic device 600 may be similar to those of any of the devices 100, 400, and 500, including an electronic image capture device 640, a battery device 660, and a signal transmission element 680. A teleidoscopic optical assembly 700 comprising at least three mirrors, which may be of conventional arrangement of kaleidoscopes and teleidoscopes and a forwardly facing lens is located at one end of the handle 620 so that the device 600 may be hand held in use, and wielded for example in the manner of a flashlight (not shown). The lens serves the function of transmitting external images into the teleidoscopic device 600 so that kaleidoscopic images may be obtained therefrom. The lens may alter optical characteristics of incoming light, such as by focusing, diffusing, etc., or alternatively may pass light without alteration. The handle 620 may be modified to assume the nature of a pistol grip handle (not shown) or to have still other configurations, if desired.

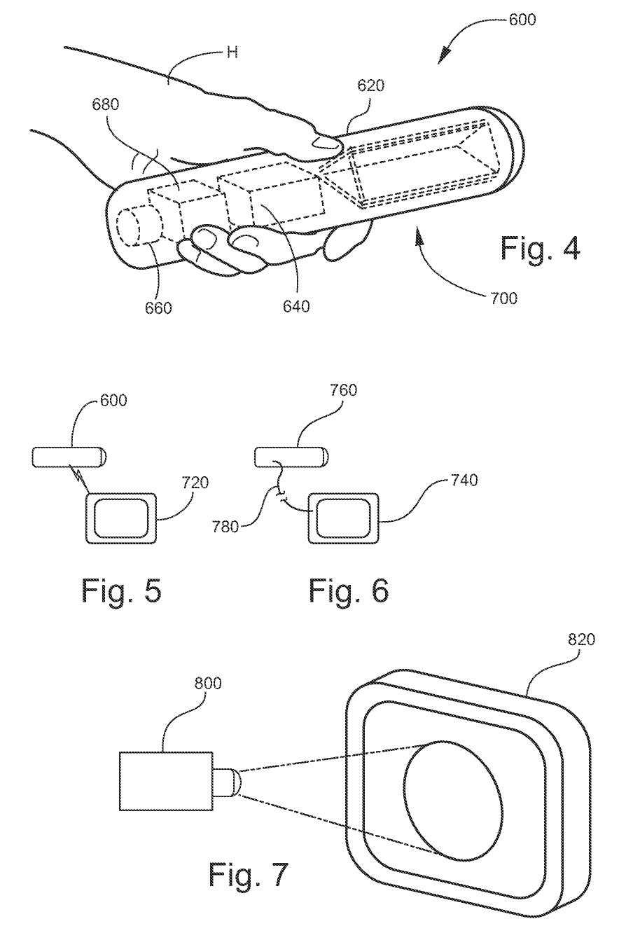

It would be possible to provide the teleidoscopic device 600 with a display screen mounted thereon (not shown). Referring now to FIGS. 5 and 6, it would be possible to provide respective physically remote display screens 720 and 740. In the arrangement of FIG. 5, the signal transmission element 680 may be a radio frequency transmitter similar to that of FIG. 2. The display screen 720 will be understood to incorporate a signal receiver (not separately shown). The teleidoscopic device 600 offers the ability to enable the user to observe the surroundings directly while capturing kaleidoscopic images of said surroundings. By contrast, this is not possible with the head worn device 100 of FIG. 1 without removing the device 100 from the head.

In FIG. 6, a teleidoscopic device 760, which may have image handling components similar to any of the devices 100, 400, 500, or 600, is modified such that it includes hard wired image transfer circuitry (symbolized by the solid conductor 780), which may be similar to that of the device 500 of FIG. 3 for example.

FIG. 7 shows an optical projector 800 which is disposed to receive kaleidoscopic images in data form from an image capture device such as the image capture device 220 of FIG. 1, and to project kaleidoscopic images in optical form onto a screen 820 or other surface which may be utilized to serve in place of a screen per se. The optical projector 800 will be understood to include signal or data reception apparatus which is compatible with either a hard wired connection such as that of FIG. 3, or with a wireless link, such as that of FIG. 2. Projection of kaleidoscopic imagery onto a screen such as the screen 820 is particularly suitable in large scale venues such as theaters, amphitheaters, stadia, exhibition halls, and the like. The screen 820 may be wall mounted, supported on a self-contained stand, or otherwise configured for deployment.

The screen 820 may be specifically a screen provided as a commercial product for displaying optical images, or alternatively may comprise any suitable surface for displaying optical images.

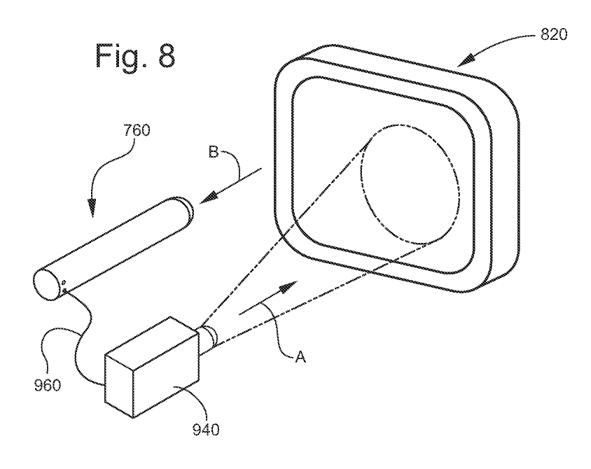

FIG. 8 shows how an optical effect may be achieved using video feedback with a teleidoscopic device which, for example, may be structurally and functionally similar to the teleidoscopic device 760 of FIG. 6. The output of kaleidoscopic imagery from the teleidoscopic device 760 may be transmitted to a projector 940 through a cable 960. The projector 940 may project input images against a screen such as the screen 820. Projection of these images to the screen 820 is indicated by the arrow A. With the teleidoscopic device 760 focused on the screen 820, video feedback may be obtained as the primary source of imagery to be kaleidoscopically processed in the teleidoscopic device 760. Acquisition of imagery by the teleidoscopic device 760 from the screen 820 is indicated by the arrow B. A closed loop may then be initiated, wherein kaleidoscopic imagery is transmitted to the projector 940, and projected onto the screen 820 where the latest imagery becomes the source material for subsequently formed kaleidoscopic images.

Any suitable teleidoscope of the types described herein may be used in the method illustrated with reference to FIG. 8. For example, the teleidoscopic device 400 of FIG. 2, the teleidoscopic device 500 of FIG. 3, and the teleidoscopic device 600 of FIG. 4 may be substituted for the teleidoscopic device 760.

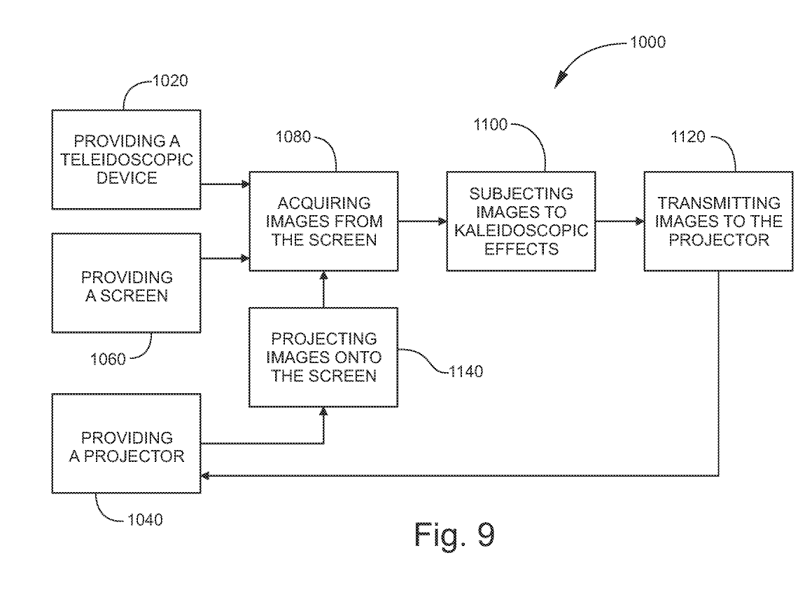

The invention may therefore also be thought of as a method of using a teleidoscope and video feedback to generate kaleidoscopic images. FIG. 9 shows steps of a method 1000 of generating kaleidoscopic images in this manner. In FIG. 9, the method 1000 is seen to comprise a step 1020 of providing a teleidoscopic device having digital image capture and transmission apparatus. The teleidoscopic device may be for example, any of the teleidoscopic devices 400, 500, 600, or 760. A step 1040 is that of providing a projector, such as the projector 940, for acquiring imagery from the teleidoscopic device and projecting acquired imagery onto a screen. The method 1000 may comprise a step 1060 of providing a screen, such as the screen 820. The method 1000 may comprise a step 1080 of acquiring images by focusing the teleidoscopic device on the screen. A step 1100 of subjecting acquired images to kaleidoscopic effects may be practiced automatically by relying on the mirror system which is part of the teleidoscopic device. The method 1000 may comprise a further step 1120 of transmitting acquired images that have been subjected to kaleidoscopic effects to the projector, and a still further step 1140 of projecting images that have been subjected to kaleidoscopic effects onto the screen.

The method 1000 may be utilized to produce a single image comprising fanciful abstract pattern. As an alternative, the steps 1020, 1040, 1060, 1080, 1100, 1120, 1140 may be repeated to generate an ongoing, endless process which may result in a constantly changing, dynamic, fanciful, abstract pattern appearing on the screen. Alternatively stated, it would be possible to repeat the steps above such that the projected visible outputted image constantly changes as a function of the phenomenon of video feedback, rather than changing as a function of focusing the teleidoscope on new subject matter in the physical environment of the teleidoscope to produce a dynamic image.

This pattern, whether the single static image, or the dynamic images resulting from video feedback, may of course be recorded in a suitable recording device such as a digital camera (not shown). Recording may be performed independently of displaying, such as by projecting kaleidoscopic images on the screen. The ongoing process may be stopped of course by disconnecting operating power from the teleidoscope or the projector.

It should further be understood that the steps of the method 1000 may be practiced in any feasible order, not only in the order presented herein.

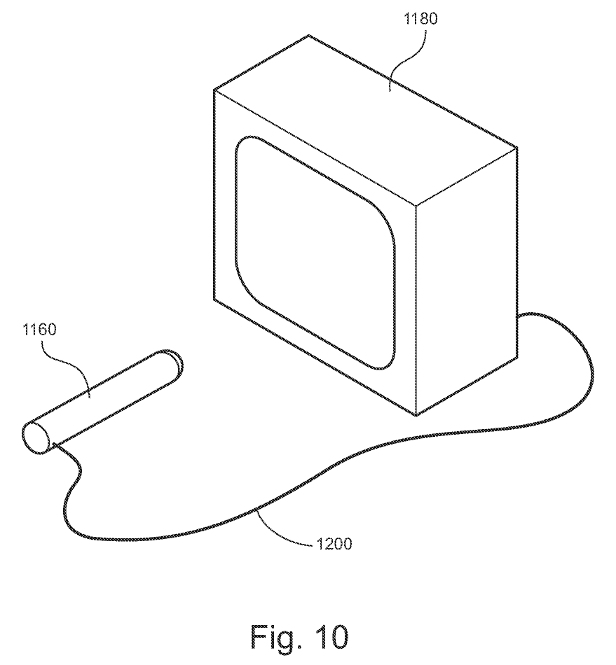

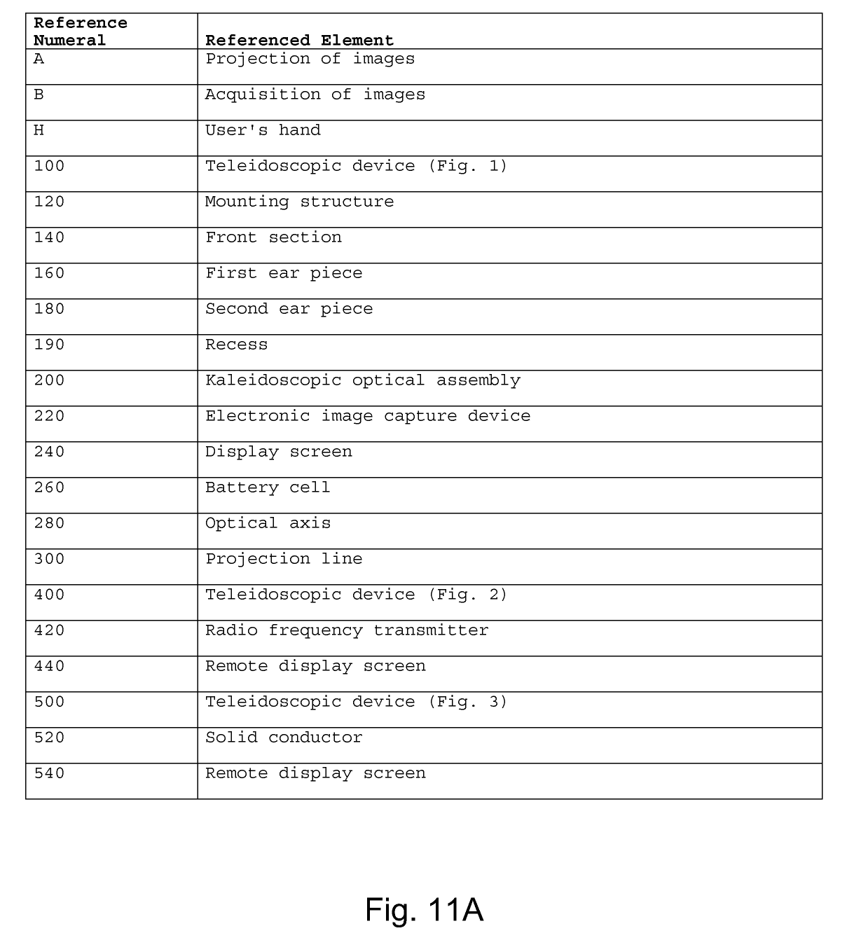

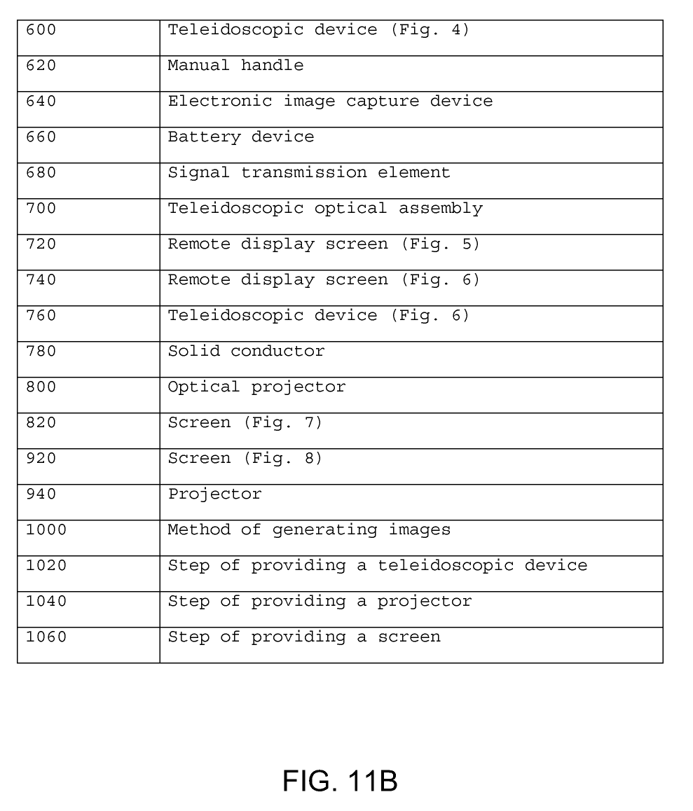

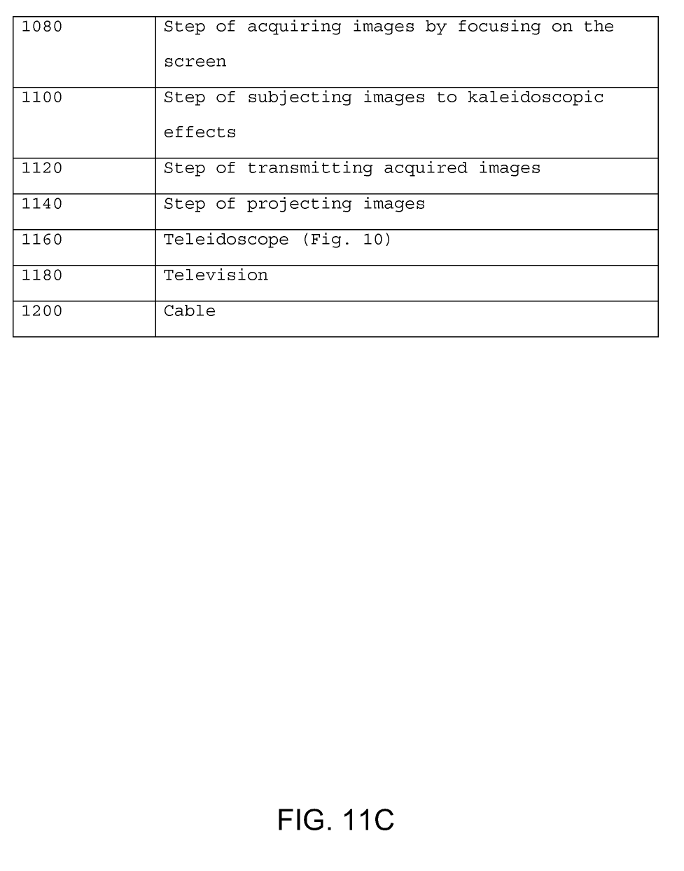

FIG. 10 shows apparatus which generally corresponds in function to that of FIG. 8, but wherein the separate projector 940 and screen 820 are replaced by a cathode ray tube device. In FIG. 10, a teleidoscope 1160 is focused on the screen of the cathode ray tube device, which is in the example of FIG. 10 a television set 1180. The teleidoscope 1160 may be for example the structural and functional equivalent of the teleidoscope 600 of FIG. 4. The input image provided to the teleidoscope 1160 is that of the television set 1180. Kaleidoscopic rendition of the input image is transmitted from the camera within the teleidoscope 1160 to the television set 1180 through a cable 1200 for example. The cable 1200 may of course be replaced by a wireless communications link (not shown). The apparatus of FIG. 10 may be used to generate the same mode of operation relying upon a video feedback loop that was described with respect to the apparatus of FIG. 8 and the method 1000 of FIG. 9. This merely requires continuous operation of the apparatus shown in FIG. 10, which will, just as with the apparatus of FIG. 8, result in a constantly changing, dynamic, fanciful, abstract pattern appearing on the screen.

The television set 1180 may be for example a flat screen television suitably located for providing entertainment to potentially large audiences.

Because a cathode ray tube device such as the television set 1180 may replace both the projector 940 and the screen 820 shown in FIG. 8, it will be appreciated that the steps of providing an image generating device and of providing a screen collectively comprise the step of providing a dynamic remote display device such as the television set 1180, wherein generated images appear on the screen of the television set 1180. A dynamic remote display device need not be limited to cathode ray tube devices and therefore may comprise any known technology such as plasma, liquid crystal, and other types. Also, the steps 1040 of providing a projector and the step 1060 of providing a screen of the method 1000 may collectively comprise the step of providing a dynamic remote display device such as the television set 1180. It will also be appreciated that cathode ray tube devices are not limited to television sets, but may comprise devices such as monitors (not shown) of personal computers.

It will be obvious that should the method 1000 be modified to rely upon a cathode ray tube device or other dynamic display device, then it will follow that the step of projecting images that have been subjected to kaleidoscopic effects onto the screen is inherent in the operation of a cathode ray tube device such as the television set 1180.

The present invention is susceptible to further variations and modifications which may be introduced thereto without departing from the inventive concepts. For example, transmission of imagery in any of the implementations of the invention, including the body supported teleidoscopic devices such as the teleidoscopic devices 100, 400, 500, 600, and 760, may be accomplished through hard wired connections including electrical and optical signals, or may rely on radiated signals, or a combination of both. The combination may include parallel or series transmission in different modes (hard wired and radiated), or both parallel and series transmission in both modes. In another example, any teleidoscopic device such as the teleidoscopic devices 100, 400, 500, 600, and 760 may use hard wired connection to remote electrical power or may use wireless power, such as operating power transmitted by radio frequency or magnetic resonance. The remote electrical power may be AC power, such as that available in building electrical receptacles, or may be a battery, power supply or other DC power source. Remote power may be connected by a hard wired connection such as conventional plug and cord for connection to building electrical receptacles and electrically conductive cables having coaxial terminals for connection to DC sources, for example.

Image transfer at any point may utilize either analog signals or digital signals.

While the present invention has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A teleidoscopic device for generating and displaying kaleidoscopic images, comprising:
a mounting structure for engaging the human body and being supported thereon;
a kaleidoscopic optical assembly disposed to generate kaleidoscopic images from the environment, said kaleidoscopic optical assembly is coupled in an operable position to said mounting structure;
an electronic image capture device disposed in image capture relation to the kaleidoscopic optical assembly;
a display screen disposed to receive images from said electronic image capture device and to display said images; and
power supply circuitry carried aboard said mounting structure and disposed to supply operating power to said electronic image capture device, wherein said power supply circuitry includes a battery device, wherein said teleidoscopic device is dimensioned and configured to be supported on the human body.

2. The teleidoscopic device according to claim 1, wherein said mounting structure comprises first and second ear pieces disposed to engage a person's ears.

3. The teleidoscopic device according to claim 2, wherein said display screen is mounted on said mounting structure.

4. The teleidoscopic device according to claim 2, wherein said first ear piece is aligned parallel to the natural direction of vision of a person, and said kaleidoscopic optical assembly is mounted on said first ear piece and is optically focused in a direction parallel to said first ear piece.

5. The teleidoscopic device according to claim 3, wherein said mounting structure comprises a front section which cooperates with the face of the person and spans and connects said two ear pieces and covers the person's eyes when said teleidoscopic device is worn, and wherein said display screen is located in front of the person's eyes when said teleidoscopic device is worn.

6. The teleidoscopic device according to claim 2, wherein said display screen is physically remote from said mounting structure, and said teleidoscopic device comprises image transmission circuitry.

7. The teleidoscopic device according to claim 6, further comprising an optical projector disposed to receive kaleidoscopic images in data form from said image capture device and to project kaleidoscopic images in optical form.

8. The teleidoscopic device according to claim 6, wherein said image transmission circuitry comprises a wireless link disposed to transfer kaleidoscopic images from said image capture device to said display screen.

9. The teleidoscopic device according to claim 6, wherein said image transmission circuitry comprises a hard wired connection extending continuously from said image capture device to said display screen.

10. The teleidoscopic device according to claim 1, wherein said mounting structure comprises a manual handle conforming to the human hand, whereby said kaleidoscopic optical assembly and said electronic image capture device may be hand held in use.

11. The teleidoscopic device according to claim 10, wherein said display is mounted on said mounting structure.

12. The teleidoscopic device according to claim 10, wherein said display is physically remote from said mounting structure.

13. The teleidoscopic device according to claim 12, further comprising an optical projector disposed to receive kaleidoscopic images in data form from said image capture device and to project kaleidoscopic images in optical form.

14. The teleidoscopic device according to claim 12, wherein said image transmission circuitry comprises a wireless link disposed to transfer kaleidoscopic images from said image capture device to said display screen.

15. The teleidoscopic device according to claim 12, wherein said image transmission circuitry comprises a hard wired connection extending continuously from said image capture device to said display screen.

16. A method of using a teleidoscope and video feedback to generate kaleidoscopic images, comprising the steps of:
providing a teleidoscopic device having digital image capture and transmission apparatus;
providing a screen;
acquiring images from the screen by focusing the teleidoscopic device on the screen;
subjecting acquired images to kaleidoscopic effects;
transmitting acquired images that have been subjected to kaleidoscopic effects to the image generating device; and
projecting images that have been subjected to kaleidoscopic effects onto the screen.

17. The method of claim 16, wherein said step of providing an image generating device and said step of providing a screen collectively comprise the step of providing a dynamic display device having a screen, wherein generated images appear on the screen.

18. The method of claim 16, comprising the further step of repeating the steps of claim 16 such that the projected visible outputted image constantly changes as a function of the phenomenon of video feedback, rather than changing as a function of focusing the teleidoscope on new subject matter in the physical environment of the teleidoscope.
